(19) United States
(12) Patent Application Publication
(10) Pub. No.: US 2025/0247512 A1
(43) Pub. Date: Jul. 31, 2025

(54) STEREO CAMERA WITH FRAMELESS IMAGE SENSING

(71) Applicant: Robotic Research OpCo, LLC, Clarksburg, MD (US)

(72) Inventor: Alberto Daniel Lacaze, Potomac, MD (US)

(21) Appl. No.: 19/038,642

(22) Filed: Jan. 27, 2025

Related U.S. Application Data
(60) Provisional application No. 63/625,476, filed on Jan. 26, 2024.

(51) Int. Cl. H04N 13/243; H04N 13/296

(52) U.S. Cl. CPC H04N 13/243; H04N 13/296

(57) ABSTRACT

A frameless image data capturing system comprises a sensor mount including one or more line scan image sensors, the sensor mount couplable to a support and a control system operatively coupled to the sensor mount and the one or more line scan image sensors, the control system comprising one or more processors and at least one memory storing computer-readable instructions that, when executed by the one or more processors, cause the one or more processors to: selectively rotate the sensor mount relative to the support; capture, with the one or more line scan image sensors, image line data of an object at defined time instances; integrate the image line data to generate stereo image data of the object; and transmit the stereo image data to a stereo image device. Each line scan image sensor may operate with a fast shutter for high-speed capture. Alternatively, each sensor includes multiple vertical lines that accumulate light in a time-sliced manner, enabling a longer effective exposure without traditional blurring.

### CROSS REFERENCE TO RELATED APPLICATION(S)

The present application claims priority to and the benefit of provisional Application Ser. No. 63/256,476, filed Jan. 26, 2024, the entire contents of which are hereby incorporated by reference herein.

### FIELD

The present disclosure relates generally to stereo camera imaging, and more particularly, relates to an omni-directional stereo camera with frameless image sensing.

### BACKGROUND

Traditional omni-directional stereo imaging uses two area scan cameras separated along a baseline to capture two slightly different viewpoints looking in the same direction. The stereo image pair can then be projected on a stereo display and fused by the human brain to generate an image that is 360-degree panoramic and stereoscopic. Such projections are useful for generating 360-degree virtual reality (VR) videos that allow a viewer to look in any direction. Area Scan cameras for omnidirectional stereo imaging utilize a pixel grid to collect an image during a single acquisition. The pixel grid is processed on a frame-by-frame basis with a frame-based camera or sensor. However, such frame-based stereo imaging is not optimal for processing the collected image data in, for example, a high-speed environment, obtaining a clear image with high resolution and facilitating data transmission.

### SUMMARY

In illustrative embodiments, the present disclosure is directed to a system and method for frameless omni-directional stereo imaging utilizing one or more frameless line cameras or sensors.

In one illustrative embodiment, a frameless image data capturing system comprises a sensor mount including one or more line scan image sensors and being couplable to a support and a control system operatively coupled to the sensor mount and the one or more line scan image sensors. The control system comprises one or more processors and at least one memory storing computer-readable instructions that, when executed by the one or more processors, cause the one or more processors to selectively rotate the sensor mount relative to the support, capture, with the one or more line scan image sensors, image line data of an object at defined time instances, integrate the image line data to generate stereo image data of the object and transmit the stereo image data to a stereo image device.

In embodiments, the sensor mount includes first and second line scan image sensors.

In some embodiments, the first and second line scan image sensors are arranged in diametric opposed relation on the sensor mount.

In other embodiments, the one or more line scan image sensors are arranged in general orthogonal relation to the object.

In embodiments, the one or more processors are further configured to control an exposure time of the one or more line scan image sensors for a predetermined sector of rotation of the sensor mount.

In some embodiments, capturing image line data includes obtaining, with the one or more image line scan sensors, multiple individual image line data at the defined time instances within the predetermined sector of rotation of the sensor mount.

In other embodiments, the one or more line scan image sensors comprise a CMOS sensor.

In embodiments, the system includes at least one additional line scan image sensor.

In some embodiments, each line scan image sensor comprises a plurality of adjacent vertical line sensors that are angularly offset relative to one another, and wherein the control system integrates partial exposures from each vertical line sensors as the sensor mount rotates, thereby creating a cumulative longer exposure for enhanced image quality.

In other embodiments, the one or more line scan image sensors are configured for fast shutter operation with short integration times, such that the control system captures images of moving objects.

In embodiments, the one or more line scan image sensors each include an event-driven architecture configured to continuously detect changes in light intensity, and wherein the control system aggregates events from multiple angular positions to produce integrated stereo image data.

In another illustrative embodiments, a method of capturing image data comprises coupling one or more line scan image sensors to a sensor mount, rotating the sensor mount, capturing, with the one or more line scan image sensors, image line data of an object at defined time instances, integrating the image line data to generate stereo image data of the object and transmitting the stereo image data to a stereo image device. The method is performed by one or more processors coupled to memory.

In embodiments, the one or more line scan image sensors include a first and second line scan image sensors.

In some embodiments, the first and second line scan image sensors are arranged in diametric opposed relation on the sensor mount.

In other embodiments, the line scan image sensors are arranged in general orthogonal relation to the object.

In embodiments, at least one additional line scan image sensor is provided.

In some embodiments, the method includes controlling an exposure time of the one or more line scan image sensors for a predetermined sector of rotation of the sensor mount.

In other embodiments, capturing image line data includes obtaining, with the one or more image line scan sensors, multiple individual image line data at the defined time instances within the predetermined sector of rotation of the sensor mount.

In embodiments, the one or more line scan image sensors comprise a CMOS sensor.

In accordance with one illustrative embodiment, the present invention is directed to an omni-directional stereo imaging system that incorporates one or more line-scan image sensors, referred to as “frameless” image sensors, instead of traditional area-scan or frame-based sensors. In certain embodiments, rather than capturing complete two-dimensional (2D) frames at once, the disclosed system captures one line of pixels at a time while the sensor mount spins or otherwise moves. More specifically, as the sensor mount rotates, each line sensor captures a vertical (or horizontal) “slice” (one line of pixels) of an object at precise time intervals. By carefully timing and stitching those lines together, the present invention produces a stereo-pair image that spans 360° degrees of the field around the camera system. At least two line sensors are positioned 180° apart (i.e., “diametrically opposed”) to provide stereo disparity-akin to two human eyes. By combining these two “lines” captured at each angle during one full 360° rotation, the system can construct stereo image data.

In accordance with an exemplary embodiment, the present invention is directed to a frameless or asynchronous image data capturing system capable of capturing image line data at defined time instances. Instead of obtaining full rectangular frame data as with conventional frame-based systems, the system captures line data at defined time instances. This enables independent control of exposure for each rotational slice of image data, reducing data overlap or redundancy common in frame-based systems.

In one embodiment, each line scan image sensor operates with a fast shutter for high-speed capture. In another embodiment, each camera sensor includes multiple line sensors or channels that accumulate light in a time-sliced manner. Each vertical line captured by the individual line sensors of the camera sensor is aligned with a different angular position, thereby enabling a longer effective exposure through sequential partial integrations across adjacent lines.

### BRIEF DESCRIPTION OF THE DRAWINGS

Where applicable, some elements may be simplified or otherwise not illustrated in order to assist in the illustration and description of underlying features. Throughout the figures, like reference numerals denote like elements. An understanding of embodiments described herein and many of the attendant advantages thereof may be readily obtained by reference to the following detailed description when considered with the accompanying drawings, wherein:

FIGS. 1 and 2 are top and side plan views of a camera apparatus of the frameless stereo imaging system in accordance with an illustrative embodiment of the present disclosure;

FIGS. 3A and 3B are top plan views illustrating actuation of the camera apparatus of the frameless stereo imaging system in accordance with an illustrative embodiment of the present disclosure;

FIG. 4 is a flow chart illustrating use of the frameless stereo imaging system in accordance with an illustrative embodiment of the present disclosure;

FIG. 5 is a top plan view of a camera apparatus of the frameless stereo imaging system in accordance with another illustrative embodiment of the present disclosure;

FIG. 6 is a flow chart illustrating use of the frameless stereo imaging system of FIG. 5 in accordance with an illustrative embodiment of the present disclosure;

FIG. 7 is a diagram illustrating an example implementation of components of the system for stereo imaging with the frameless image sensing system in accordance with an illustrative embodiment of the present disclosure;

FIG. 8 is a block diagram illustrating an exemplary autonomous vehicle system incorporating the frameless imaging system in accordance with in accordance with an illustrative embodiment of the present disclosure; and

FIG. 9 depicts a generalized example of a computing environment in which the disclosed technologies may be implemented in accordance with an illustrative embodiment of the present disclosure.

### DETAILED DESCRIPTION

### I. Introduction

In the following detailed description of the invention of exemplary embodiments of the invention, reference is made to the accompanying drawings (where like numbers represent like elements), which form a part hereof, and in which is shown by way of illustration specific exemplary embodiments in which the disclosure may be practiced. These embodiments are described in sufficient detail to enable those skilled in the art to practice the disclosure, but other embodiments may be utilized and logical, mechanical, electrical, and other changes may be made without departing from the scope of the present disclosure. The following detailed description is, therefore, not to be taken in a limiting sense.

In the following description, numerous specific details are set forth to provide a thorough understanding of the present disclosure. However, it is understood that the disclosure may be practiced without these specific details. In other instances, well-known structures and techniques known to one of ordinary skill in the art have not been shown in detail in order not to obscure the present disclosure. Referring to the figures, it is possible to see the various major elements constituting the system and apparatus of the present disclosure.

### II. Illustrative Embodiments

Line scan imaging incorporates a single line sensor or camera with a single-row of light sensitive pixels to capture individual image lines of a line scan accompanied by high-intensity lighting. Line-scan cameras or sensors excel at producing images of objects in continuous motion past a fixed point. A completed image is built by stitching together and/or integrating the line data. Two-dimensional images are acquired line by line by successive single-line scans while the object moves in relative perpendicular or orthogonal relation past the line of pixels in the image or line sensor.

Line scan imaging provides a cost-effective implementation with high spatial resolution image capture and a dynamic range with clear images without excessive processing requirements. Line scan imaging eliminates frame overlaps required to build an image with area scan cameras or sensors. Frame overlaps represent redundant data that consumes precious processing bandwidth, particularly in high-speed, high-resolution applications. For a given field of view, a line scan camera can provide more resolution than multiple area scan cameras without image smear or redundant processing associated with frame overlaps.

With line scan imaging, the time between exposure and readout is the “line rate,” calculated in kilohertz (kHz). Line scan imaging has application in stereo imaging or omnidirectional stereo imaging and viewing. These imaging sensors include cameras having linear scan sensors raging between about 4,000 pixels to 16,000 pixels and provide both high resolution and a large field of view without the massive overload associated with large two dimensional (2D) frame based systems. Linear sensors have line rates of up to 50 kHz even at extremely high resolutions. Stereo line-scan sensors are oriented perpendicular to the object surface. Lighting is significant in stereo or 3D imaging. For high speed, the sensors line rate is increased, resulting in a decreased available exposure time, and increased illumination intensity.

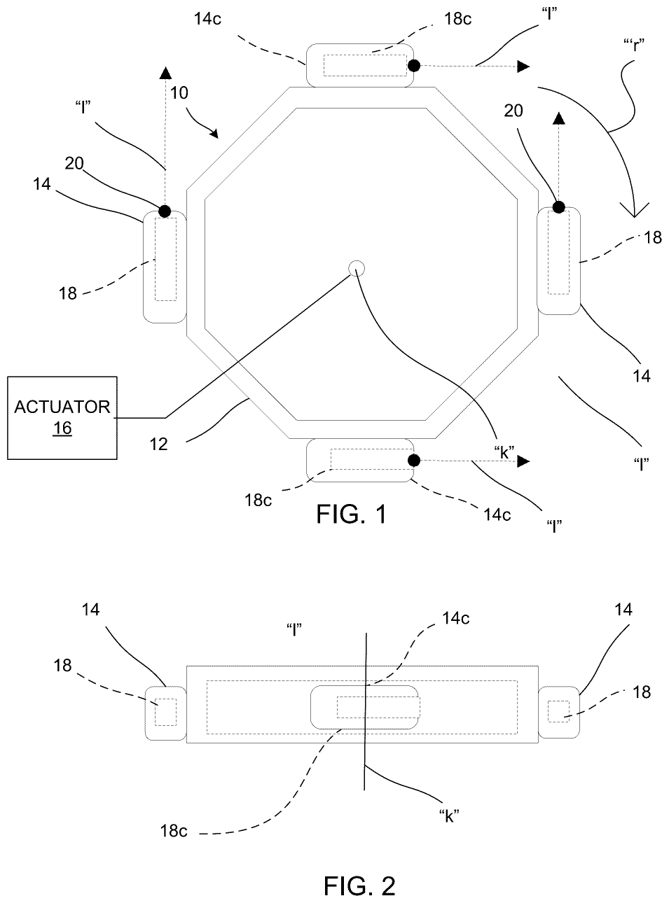

FIGS. 1 and 2 illustrate an imaging apparatus of a frameless or asynchronous stereo imaging system 10 in accordance with an illustrative embodiment of the present disclosure. The imaging apparatus includes a sensor or sensor mount 12 configured for rotational movement in at least one rotational direction (designated as arrow “r”) about a central axis “k” extending through the center of the sensor mount 12. In other embodiments, the sensor mount 12 may rotate in the opposite direction or may selectively reciprocate in both rotational directions. The sensor mount 12 may be mounted to a support (not shown) in rotatable relation to the support. One or more line camera units 14 are mounted or coupled to the sensor mount 12. The sensor mount 12 may be any component configured to support the line camera unit 14. In embodiments, the sensor mount 12 is generally annular in configuration and defines a dimension or diameter that is approximate to the interpupillary distance between a user's eyes to enable stereoscopic processing. The sensor mount 12 is mechanically connected to an actuator 16 which effects the rotational movement of the sensor mount 12. The actuator 16 may be any suitable motor configured to impart continuous or intermittent rotation of the sensor mount 12 about the axis “k.”

The one or more camera units 14 each include at least one image scan line sensor 18 and optics for supporting the line sensors 18. The line sensors 18 may be any suitable commercially available line sensor configured for frameless image data capture. In illustrative embodiments, the line sensors 18 may be a charge-coupled device (CCD) or a complementary metal oxide-semiconductor (CMOS). CCD image sensors exhibit relatively high fill factor, low noise and high sensitivity. CMOS image sensors exhibit high frame rate and readout, low power consumption and good performance in brightly lit environments. Other suitable sensors include back-side illuminated (BSI) and front-side illuminated (FSI) sensors. In embodiments, the liner sensors 18 each may be a 4,000 pixel line sensor, an 8,000 pixel line sensor or a 16,000 pixel line sensor. Other pixel sizes are also envisioned. In embodiments, the line sensors 18 are color line sensors which include, for example, trilinear technology or prism-based multi-sensor technology. The line sensors 18 define linear or line pixel scans identified as lines “l′ in FIG. 1. In embodiments, the line sensors 18 are arranged to project line pixel scans against at least a vertical surface in orthogonal relation to the vertical surface. In the alternative, the line sensors 18 may be arranged to project pixel line scans against a horizontal surface or both a horizontal and/or vertical surface. The captured line scans are processed or integrated by software to create an image, e.g., a stereoscopic three (3D) image.

With continued reference to FIGS. 1 and 2, in order to provide stereoscopic imaging or perception, the camera units 14 and the line sensors 18 are disposed on opposed sides of the sensor mount 12 at a one hundred eighty) (180° degree of separation, e.g., diametrically opposed, and may be directed radially outward away from the center of the sensor mount 12. In illustrative embodiments, the distance between each line camera unit 14 is ½ of the desired eye disparity to match human horizontal eye disparities. One rotation of the sensor mount 12 and associated line camera units 14 and line sensors 18 through an angle of rotation of three hundred sixty (360) degrees is equivalent to a frame. In embodiments, one or more additional pairs of line cameras 14c with line sensors 18c (each shown in phantom) may be provided offset ninety) (90° degrees relative to the first pair. This would increase the frame rate proportionally. For example, an additional pair of image line sensors will double the frame rate. Additional pairs of cameras 16c and associated line sensors 18c beyond two pairs are also envisioned. The additional pairs of cameras 14 will proportionally increase line rate or frame rate of the apparatus 10.

In illustrative embodiments, the frameless line sensors 18 capture linear or line image data of an object in defined time instances during rotation of the sensor mount 12 about the axis “k.” The collected or sampled individual image line data is processed/integrated to generate stereo pair data which may be transmitted to a stereo visualization device such as stereo goggles. In embodiments, the line sensors 18 sample or capture image line data (e.g., multiple instances of image line data) at defined time increments to generate two images, i.e., the stereo pair data, which have the correct disparity or offset to show stereo. This is due to the fixed relationship of the camera units 14 and line sensors 18 on the sensor mount 12, which is known and constant throughout data capture. This provides an enhanced presentation of the range of the object.

In illustrative embodiments, the two line camera units 14 with sensors 18 positioned 180° apart may also capture slight differences (e.g., disparities) in the same directions over time, in that the line sensors 18 capture or view the environment from different vantage points as the mount rotates. Each rotation path of the line sensor 18 overlaps with the path of the other line sensor 18, which creates a stereo baseline (i.e., the physical separation between the line sensors 14 or camera units 14) to reconstruct three dimensional (3D) information over the entire circle. Thus, rotation of the sensor mount 12 ensures each line sensor 18 views the same directions over one revolution.

The line image or data of the object captured by the image line sensors 18 does not require extensive processing by a processor (such as blending, mixing or stitching) to generate the stereo pair image data sent to the stereo vision device. Thus, data processing demands on a processor are reduced and data transmission is facilitated to one or more stereo vision devices. This provides significant advantages over frame based area scan cameras which require processing, e.g., blending and transmission, of area image data to the stereo vision device.

In some embodiments, line image data may be sampled or taken by the frameless line sensors 14 for defined time interval(s) corresponding to an exposure time of the image line camera unit(s) 14. Thus during rotation of the sensor mount 12 through a predefined sector of rotation corresponding to a length of exposure or exposure time, image line data may be captured by the image line sensors 18 at defined instances or increments within the exposure time. For example, and without limitation, the rotatable mount 12 may rotate through an angle of rotation of a five) (5° degree sector of rotation, corresponding to an exposure time of the image line sensors 18. Multiple or individual image line data of the object may be sampled or captured by the image line sensors 14 during the exposure time, for example, at one) (1° degree, two (2°) degrees, three (3°) degrees, etc., at different times, and the captured image line data is integrated/processed by, for example, an image processor to provide a highly resolved image with minimal blur and/or high image resolution. This provides an increased exposure time capability which provides benefits with image resolution, sensor light requirements, data transmission etc. In other illustrative embodiments, the camera units 14 and the image line sensors 18 may be arranged to project line pixel scans downwardly relative to the rotatable mount 12 against at least a horizontal surface.

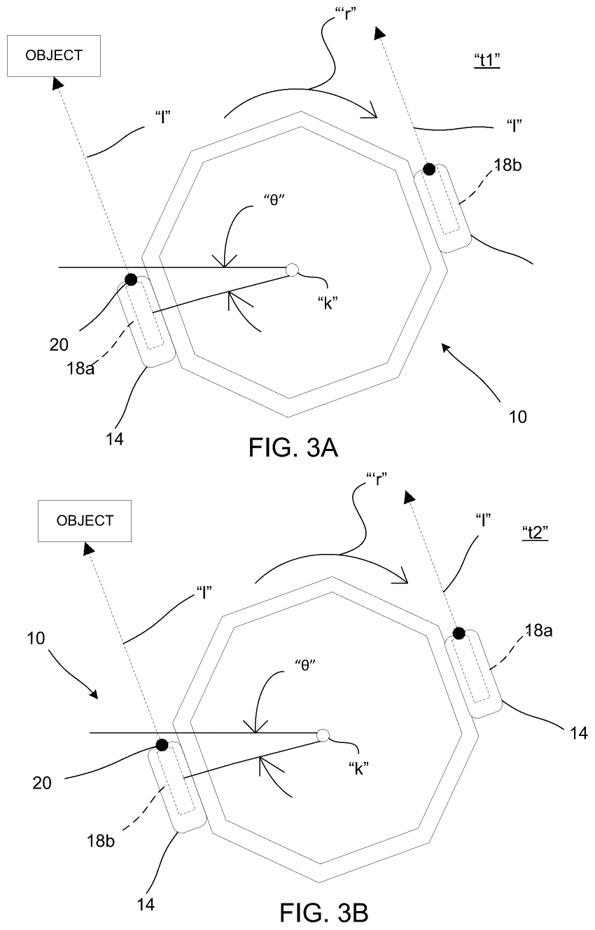

In embodiments, and with reference to FIGS. 3A and 3B, the positioning and arrangement of the line sensors 18 of each camera unit 14 results in the line sensors 18 viewing outwardly relative to the longitudinal axis “k” during rotation of the rotatable mount 12 in the direction “r.” Thus, during one full rotation, each line sensor 18a, 18b of respective diametrically opposed camera units 14a, 14b observes all directions across the panoramic view. at a 180° spacing on the rotatable mount 12. The rotational speed of the rotatable mount 12 and the precise position of the line sensors 18a, 18b relative to the sensor mount 12 is known. Thus, the system 10 can track each line of pixels for each line sensor 14. For example, when a first line sensor 18a of a first camera unit 14a is at angle θ at time t₁ (FIG. 3A) and the second line sensor 18b (180° away) reaches that same scene direction or angle θ at time t₂ (FIG. 3B), the system records two lines that depict the same direction but from the two different vantage points (i.e., the separation of the line sensors 18a, 18b is the stereo baseline). In FIGS. 3A and 3B, optional additional camera units 14 with line sensors 18c are not shown for clarity purposes.

Frameless stereo imaging with multiple line sensors 18 captures depth information using a pair of line sensors. In embodiments, mirrors, represented schematically as reference numeral 20 in FIGS. 1-3B, may be integrated with the line sensors 18 to enhance stereo imaging. The mirrors 20 can create multiple perspectives of the same scene for a single line sensor, enabling stereo depth calculations without needing two separate sensors. In some embodiments, the mirrors 20 may rotate through one or more linear actuators to provide a pseudo-2D imaging device for depth mapping. The mirrors 20 may include mirrors with reflective coatings to prevent double images caused by secondary reflections; parabolic mirrors to facilitate focusing of light; beam-split mirrors to split incoming light into multiple paths in stereo applications requiring simultaneous views from different angular orientations; flat mirrors; elliptical mirrors to focus light paths to specific orientations; and scanning mirrors which are motorized to be used in a moving object or field.

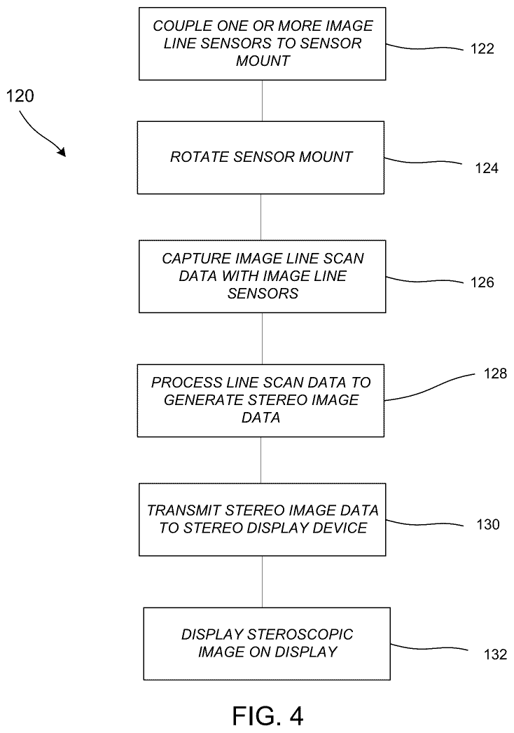

FIG. 4 is a process flow diagram illustrating the use of one exemplative embodiment of the frameless stereo imaging system in generating and transmitting image data to a stereo vision device. In the exemplative embodiment, the process 120 is initiated by providing the apparatus 10 of FIGS. 1 and 2 having at least one pair of the opposed camera units 14 and image line sensors 18 coupled thereto. (STEP 122) In embodiments, the sensor mount 12 is arranged relative to the object or frame such that the image line sensors 18 extend orthogonal (FIGS. 1 and 2) to the object. The actuator 16 is actuated to cause rotational movement of the sensor mount 12 about the longitudinal axis “k” at a known or predetermined rotational speed. (STEP 124). In STEP 126, in concert with rotation of the sensor mount 12, the line sensors 18 of the cameras 12 are activated to capture image line scan data of the object. In embodiments, the line sensors 14 may capture image line data of an object at one defined angular orientation. For example, the line sensors 18 may capture image line data through a predefined angular sector of rotation and/or through defined increments within the predefined angular sector of rotation such as, without limitation, a five 5° angular sector of rotation and/or at single one) (1° degree increments within the five) (5° angular sector of rotation. The individual image line scan data is processed and/or integrated by one or more image processors to generate stereo image data. (STEP 128). The stereo image data is forwarded to the viewing device for stereo imaging, e.g., such as omni-directional stereo imaging. (STEP 130). The stereo image is displayed on the stereo display device (STEP 132). The stereo image display device may include a stereoscope, stereo goggles, stereo glasses or other imaging device.

In embodiments, the image line data captured by each line sensor 18 may be integrated after each line sensor 18 passes a given component (image line) of the object. More specifically, since the rotational speed of the sensor mount 12 is known, the timing difference between collection of the image line data of the line sensors 18 at a particular instance may be calculated and integrated to generate the stereo image data associated with the captured line image. This calculation is generally straightforward in a static environment or object. In the event the environment or object is moving, captured line data of the line sensors 18 may be integrated provided the linear or rotational speed of the object or environment is known. Hence, the “stereo effect” does not require both line sensors 18 to look in the same direction at the same moment, because the rotation and precise timing/position tracking lets the system reconstruct left and right views for every direction over a 360° sweep. In this manner, correct left/right eye disparity for stereo may be achieved, despite not conforming to the usual forward-facing design of conventional stereo systems.

If the scene includes moving objects, a rotating stereo imaging system 10 that relies on time-sequenced capture will face the potential for temporal mismatch between the two camera units 14 and sensors 18. In a conventional stereo camera where both lenses point in the same direction at the same instant, the two images naturally represent the scene at essentially the same time, which keeps moving elements in register. With a rotating, line-scan approach incorporated within the stereo imaging system 10, each line sensor 18 arrives or “visits” the same angle at different times. For a static or slowly moving scene, that time difference may be negligible and can be managed via calibration and timing. However, faster-moving objects (people, vehicles, etc.) could shift position when the first line sensor 18a scans a particular angle and the second diametrically opposed line sensor 18b reaches that same angle (FIGS. 3A and 3B). This can result in stereo mismatch or motion artifacts. To mitigate this challenge, in embodiments, the rotational speed of the sensor mount 12 may be increased to a defined rotational rate or speed in which the offset between the left and right “views” of a moving object becomes less noticeable, i.e., the individual line sensors 18 reach a given angular position almost simultaneously. For more complex systems, the controller may incorporate motion-tracking or predictive logic or modeling to compensate for the positional shifts in the moving objects.

In some embodiments such as in an industrial application or inspection line in which the “object” or scene speed is known and controlled, carefully synchronizing rotation speed of the sensor mount 12 with object flow or movement can reduce mismatch. In applications involving truly dynamic scenes, there is a potential for at least some, albeit minimal, offset or mismatch; however, the particularly high resolution and full 360° coverage provided by the frameless or asynchronous stereo imaging system 10 will offset any downside particularly if rotation of the sensor mount 12 is well-managed and synchronized or if the scene does not move too quickly.

In illustrative embodiments, during capturing of image line scan data (STEP 126), the exposure time of the image line sensor(s) 18 may be controlled through a predefined angular sector of revolution of the sensor mount 12. The image line data may be sampled at time instances within the exposure time period, and integrated through image processing software to produce a highly resolved image.

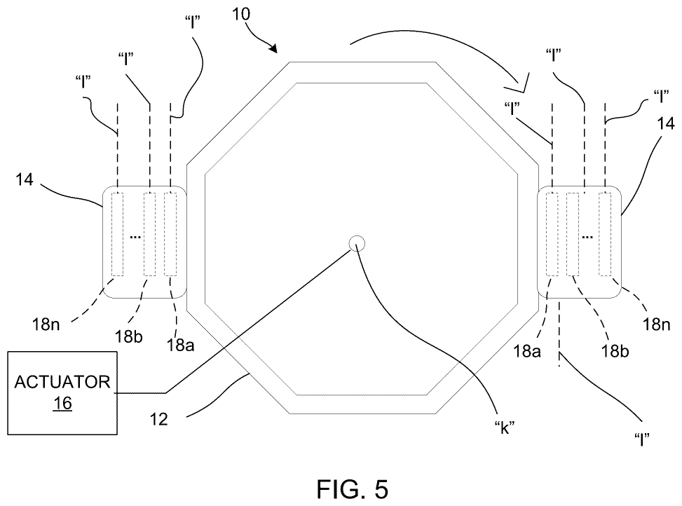

With reference now to FIG. 5, another illustrative embodiment of the present disclosure is illustrated In accordance with this exemplary embodiment, each camera unit 14 is configured with multiple vertically adjacent line-scan channels, i.e., includes multiple line sensors 18a1, 18b1 . . . 18n, arranged in side by side relation, e.g., offset angularly relative to the axis “k.” For example, and without limitation, each camera unit 14 may include ten (10), twenty (20), one (1) hundred or more individual line sensors 18a, 18b . . . 18n. As the sensor mount 12 rotates, each individual vertical line channel or line sensor 18a, 18b . . . 18n within the camera unit 14 aligns with the target object for a short interval capturing partial images. For example, as the sensor mount 12 rotates at, e.g., 1° per millisecond, each line sensor 18 in the camera unit 14 views the same object in sequence, for a fraction of the rotation. By time-slicing and integrating signals from each of the adjacent vertical channels, i.e., line sensors 18a, 18b . . . 18n, in sequence, the system effectively attains a longer cumulative exposure time without traditional blurring. This approach can be used with event-driven or shutterless cameras, which continuously collect photons and report changes, allowing the processor to aggregate these signals over multiple angular segments. By adding or integrating these sequential segments of illumination across the different vertical slices, a longer total exposure is gained while still only exposing each slice for a short time window. Otherwise stated, in some illustrative embodiments, the system 10 includes a time/angle-multiplexed accumulation that exploits the geometry of multiple vertical lines scanning across the same object in sequence. By “stacking up” or summing these exposures over the time it takes for each camera unit 14 to sweep across the object, the system can achieve a longer effective exposure without traditional motion blur. This approach blends the ideas of omnidirectional line-scan with continuous event-driven or shutterless imaging.

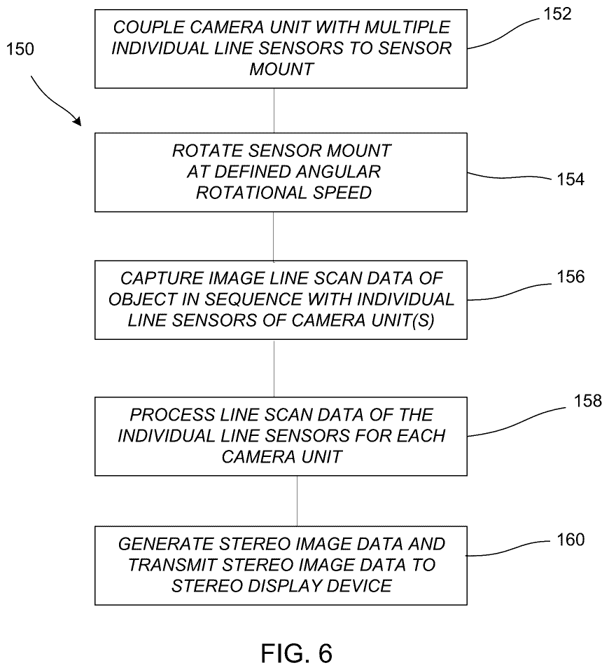

FIG. 6 is a process flow diagram illustrating the use of multiple line sensors 18a, 18b . . . 18n or image channels in each camera unit 14 described in FIG. 5 in accordance with one exemplative embodiment of the frameless stereo imaging system 10. In this exemplative embodiment, the process 150 is initiated by providing the apparatus 10 of FIGS. 1-3B in which each camera unit 14 includes multiple individual image line sensors 18a, 18b . . . 18n arranged in side-by-side relation within each camera unit 14. (STEP 152). The actuator 16 is actuated to cause rotational movement of the sensor mount 12 about the longitudinal axis “k” at a known or predetermined rotational speed. (STEP 154). As the sensor mount 12 rotates, each individual line sensor 18a, 18b . . . 18n within the camera unit 14 aligns with the target object for a defined short interval based on the angular speed of rotation of the sensor mount 12, i.e. for a fraction of the angular rotation, to capture image line scan data. 156). This is performed for each camera unit 14 on the sensor mount 12, e.g., for the diametric opposed camera units 14. The image line data captured by each individual line sensor 18a, 18b . . . 18n of the camera units 14 is integrated and processed, and thereafter directed to the stereo display unit (STEP 160).

In illustrative embodiments, the system may use fast shutter imagers (e.g., short integration times on a single line) to reduce motion blur in high-speed scenarios. The control system can dynamically switch between fast shutter mode and time-sliced accumulation mode, optimizing for scene brightness and motion. More specifically, the cameras 14 may operate in two (2) modes 1) fast shutter for high-speed scenes, e.g., short integration times on a single line sensor 14; and 2) time-sliced mode for low-light or when longer effective exposure is needed.

In illustrative embodiments, the system of the present disclosure may be used in autonomous driving vehicles, augmented reality and robotics navigation activities. Other applications are also envisioned.

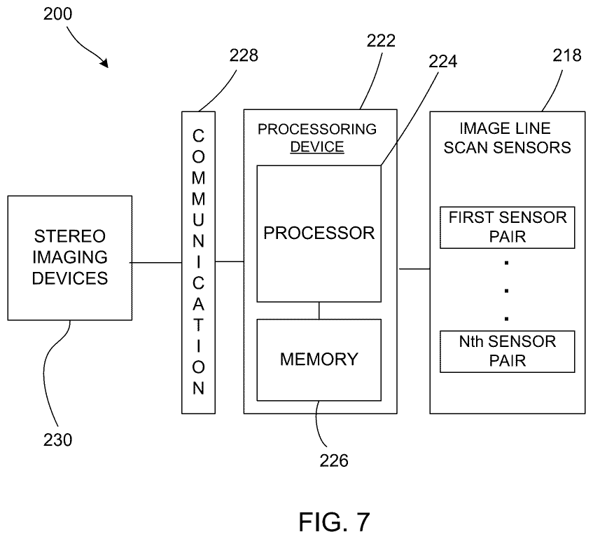

FIG. 7 is a diagram illustrating an example implementation of components of the system for stereo imaging with frameless image sensing in accordance with one or more illustrative embodiments of the present disclosure. The system 200 includes the line sensors 218 as part of the cameras. In illustrative embodiments, the line sensors 218 may include at least a first pair of frameless line sensors and additional pairs of frameless sensors 218 up to an nth pair of line sensors 218. Multiple individual line sensors 218 within each camera unit 14 as described in connection with FIG. 5 are also contemplated. The individual line sensors 218 of each pair are coupled to the sensor mount in opposed relation, e.g., 180° (degrees) apart. Each of the other pairs of the image line sensors 218 are offset to the first pair at defined angular relationships with individual line sensors 218 of each pair in opposed relation (i.e., 180 degrees apart). Other offset arrangements are also envisioned. The frameless line sensors 218 are in communication with a processing device 222 having one or more processors 224 coupled to one or more memories 226. In the illustrated example, the one or more processors 224 execute computer-executable instructions including software or logic for processing the collected image scan data to integrate th data and form a stereoscopic image. The one or more memories 226 stores software or instructions implementing one or more innovations described herein, in the form of computer-executable instructions suitable for execution by the processing unit(s). In embodiments, the one or more processors 224 process the image scan data into a stereo image pair data.

A communication device 228 enables communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier. The communication device 228 may be in communication with one or more networks to transfer the stereo image data to selected one or more stereo image devices 230. The one or more stereo image devices 230 may be any stereo image device including without limitations, stereo goggles or the like capable of converting stereo pair data into three dimensional images.

In illustrative embodiments, the frameless or asynchronous stereo imaging system and/or methodology includes a rotatable sensor mount that supports one or more line-scan cameras or sensors. As the mount rotates, each sensor captures a vertical (or horizontal) “slice” (one line of pixels) of the environment at precise time intervals. In certain embodiments, at least two line sensors are positioned one hundred eighty degrees) (180° apart (i.e., “diametrically opposed”) to provide stereo disparity-akin to two human eyes. By combining these two “lines” or slices captured at each angle during one full 360° rotation, the system can construct stereo image data. Moreover, instead of taking full rectangular frame images as performed with conventional systems, the stereo imaging system captures lines at defined time instances. This enables independent control of exposure for each rotational slice, reducing data overlap or redundancy common in frame-based systems.

In embodiments, as the rotatable sensor mount spins through 360°, each line-scan sensor 18 sweeps out a full panorama. Two line sensors positioned 180° apart, effectively capture slight differences (e.g., disparities) in the same directions over time, because they each see the environment from different vantage points as the mount rotates. Instead of building a stereo pair in one forward-facing shot, the system gathers “line” data continuously as it rotates. Each sensor's rotation path overlaps with the other sensor's path, which creates enough stereo baseline (i.e., the physical separation between the sensors) to reconstruct 3D information over the entire circle. The present invention eliminates frame overlaps associated with traditional omni-directional stereo arrangements using area-scan cameras which produce overlapping frames and redundant data. Moreover, the continuous, asynchronous rotation of the sensor mount provides 360° image coverage in an efficient manner rather than using multiple static cameras in conventional systems. Due to the ability to capture one image or scan line at a time, exposure can be tuned for different angular sectors, which helps manage varied lighting conditions without needing high-speed global shutters across an entire 2D sensor.

The line-scan sensors of the frameless system of the present invention can have high pixel counts per line, for example, about 4,000 to 16,000+pixels wide. Thus, the system can achieve very high resolution without the massive overhead of conventional large two dimensional (2D) frame systems. The rotational approach means only minimal blending or stitching is needed—just line-by-line integration rather than large frame-based overlaps. After the raw line data is collected for a full rotation of the sensor mount, the processor integrates the data into stereo image pairs, which can be fed to virtual reality (VR) or other stereo display devices (e.g., goggles or heads-up displays).

The frameless system and methodology of the present invention can be integrated into autonomous vehicles, augmented/virtual reality systems, robotics, and other areas which may require 360° degree stereoscopic vision including, for example, industrial inspection, surveillance, or other environments requiring fast, high-resolution imaging in all directions.

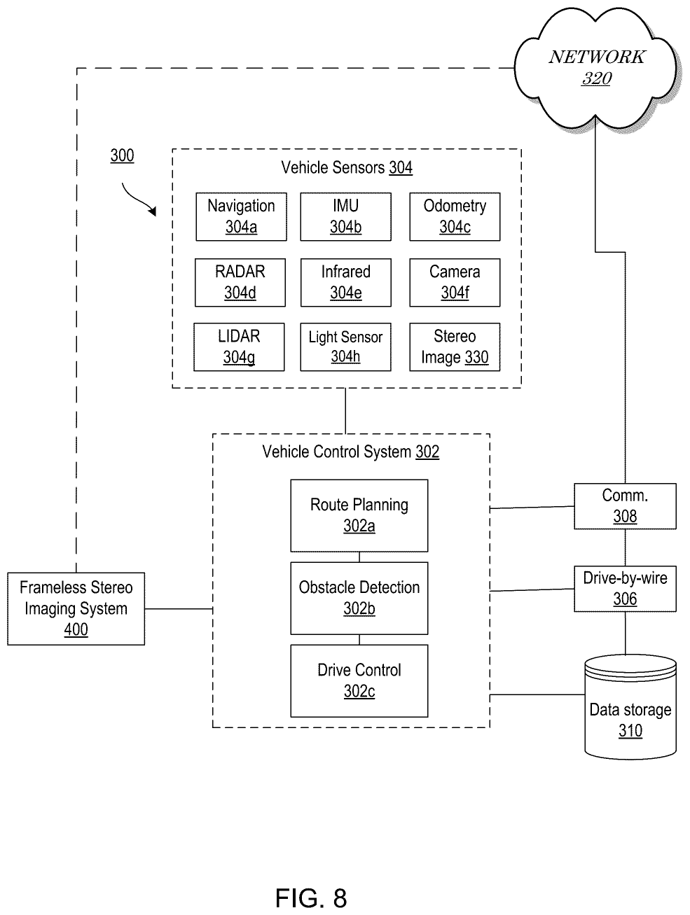

FIG. 8 illustrates an exemplary configuration of a vehicle apparatus 300 adapted for autonomous or semi-autonomous operation, which may utilize a frameless stereoscopic imaging system 400, for example, for navigation and image detection. The frameless stereoscopic imaging system 400 may be substantially similar or identical to the frameless stereoscopic imaging systems of FIGS. 1-7. In embodiments, the frameless stereoscopic imaging system 400 may be fully incorporated into the vehicle apparatus 300, and may be integrated with other sensors of the vehicle. In other embodiments, only select components of the frameless stereoscopic imaging system 400 may be incorporated into the vehicle apparatus 300 including, for example, a stereoscopic imaging device. The vehicle apparatus 300 can include a vehicle control system 302, one or more vehicle sensors 304, a drive-by-wire system 306 and a communication unit 308. The drive-by-wire system 306 can include, for example, electrical and/or electro-mechanical components for performing one or more vehicle functions traditionally provided by mechanical linkages, e.g., braking, gearing, acceleration, and/or steering. In some embodiments, the vehicle apparatus 300 can further include one or more memories or databases 310. For example, the vehicle apparatus 300 can include one or more data storage or databases 310 that store driving rules (e.g., “rules of the road”) and/or a road or terrain map of an area in which the vehicle operates. Alternatively or additionally, one or more databases 310 can include instructions for processing images captured by the stereoscopic imaging system 400.

In some embodiments, the vehicle sensors 304 can include a navigation sensor 304a, an inertial measurement unit (IMU) 304b, an odometry sensor 304c, a RADAR system 304d, an infrared (IR) imager or sensor 304e, a visual camera sensor 304f, a LIDAR sensor system 304g, and one or more light sensors 304h. Other sensors are also possible according to one or more contemplated embodiments. For example, sensors 304 can further include an ultrasonic or acoustic sensor for detecting distance or proximity to objects, a compass to measure heading, inclinometer to measure an inclination of a path traveled by the vehicle (e.g., to assess if the vehicle may be subject to slippage), ranging radios (e.g., as disclosed in U.S. Pat. No. 11,234,201, incorporated herein by reference), or any combination thereof.

In some embodiments, the navigation sensor 304a can be used to determine relative or absolute position of the vehicle. For example, the navigation sensor 304a can comprise one or more global navigation satellite systems (GNSS), such as a global positioning system (GPS) device. In some embodiments, IMU 304b can be used to determine orientation or position of the vehicle. In some embodiments, the IMU 304b can comprise one or more gyroscopes or accelerometers, such as a microelectromechanical system (MEMS) gyroscope or MEMS accelerometer.

In some embodiments, the odometry sensor 304c can detect a change in position of the vehicle over time (e.g., distance). In some embodiments, odometry sensors 304c can be provided for one, some, or all of wheels of the vehicle, for example, to measure corresponding wheel speed, rotation, and/or revolutions per unit time, which measurements can then be correlated to change in position of the vehicle. For example, the odometry sensor 304c can include an encoder, a Hall effect sensor measuring speed, or any combination thereof.

In some embodiments, the RADAR system 304d can use irradiation with radio frequency waves to detect obstacles or features within an environment surrounding the vehicle. In some embodiment, the RADAR system 304d can be configured to detect a distance, position, and/or movement vector of a feature (e.g., obstacle) within the environment. For example, the RADAR system 304d can include a transmitter that generates electromagnetic waves (e.g., radio frequency or microwaves), and a receiver that detects electromagnetic waves reflected back from the environment.

In some embodiments, the IR sensor 304e can detect infrared radiation from an environment surrounding the vehicle. In some embodiments, the IR sensor 304e can detect obstacles or features in low-light level or dark conditions, for example, by including an IR light source (e.g., IR light-emitting diode (LED)) for illuminating the surrounding environment. Alternatively or additionally, in some embodiments, the IR sensor 304e can be configured to measure temperature based on detected IR radiation, for example, to assist in classifying a detected feature or obstacle as a person or vehicle.

In some embodiments, the camera sensor 304f can detect visible light radiation from the environment, for example, to determine features (e.g., obstacles) within the environment and/or features of the trailer (e.g., gladhand receptacle). For example, the camera sensor 304f can include an imaging sensor array (e.g., a charge-coupled device (CCD) or complementary metal-oxide semiconductor (CMOS) sensor) and associated optical assembly for directing light onto a detection surface of the sensor array (e.g., lenses, filters, mirrors, etc.). In some embodiments, multiple camera sensors 304f can be provided in a stereo configuration, for example, to provide depth measurements.

In some embodiments, the LIDAR sensor system 304g can include an illumination light source (e.g., laser or laser diode), an optical assembly for directing light to/from the system (e.g., one or more static or moving mirrors (such as a rotating mirror), phased arrays, lens, filters, etc.), and a photodetector (e.g., a solid-state photodiode or photomultiplier). In some embodiments, the LIDAR sensor system 304g can use laser illumination to measure distances to obstacles or features within an environment surrounding the trailer. In some embodiments, the LIDAR sensor system 304g can be configured with a field-of-view primarily directed to detect features at the rear and/or sides of the trailer. Alternatively or additionally, in some embodiments, the LIDAR sensor system 304g can be used to identify the loading dock and/or measure features thereof. Alternatively or additionally, in some embodiments, the LIDAR sensor system 304g can be configured to provide three-dimensional imaging data of the environment, and the imaging data can be processed (e.g., by the LIDAR system itself or by a module of control system 302) to generate a view of the environment (e.g., at least a 180-degree view, a 270-degree view, or a 360-degree view).

In some embodiments, the one or more light sensors 304h, in embodiments, include one or more light emitters arranged to emit light onto the vehicle apparatus 300 or to a vehicle to which the vehicle apparatus will be coupled. The emitted light may be used as a visual aid to facilitate capture of images by the camera sensor 304f. In embodiments, the one or more light sensors includes one or more light detectors. The light detectors collect visual data of the emitted light. The visual data is processed by the control system or the light sensor module to control movement of the vehicle apparatus 300 or any accessories associated with the vehicle apparatus 300 includes robotics, end effects gladhand couplers etc.

The vehicle sensors 304 can be operatively coupled to the control system 302, such that the control system 302 can receive data signals from the sensors 304 and control operation of the vehicle apparatus 300 (e.g., hostler), or components thereof (e.g., drive-by-wire system 306, communication unit 308, etc.) or the frameless stereoscopic imaging system 400.

The vehicle apparatus 300 may further include or be associated with a stereo image device 330. The stereo image device 330 may be similar to the stereo image device 230 of the frameless stereoscopic imaging system 200, and may be utilized in place of the stereo image device 230 or in combination therewith. The stereo imaging device 330 may be mounted relative to the frame of the vehicle apparatus 300 or may be portable and made accessible by the vehicle apparatus 300. In embodiments, the stereo image device 330 includes a screen, goggles, glasses or etc. The stereo image device 330 may be in communication with the components of the frameless stereo imaging system 400 via, for example, communication unit 308, or other communication modalities described hereinabove, and adapted to receive stereoscopic image data for visualization on the stereoscopic image device 330.

FIG. 8 further illustrates a configuration of a vehicle control system 302 that includes, in accordance with some embodiments, one or more modules, programs, software engines or processor instructions for performing at least some of the functionalities described herein. The control system 302 includes, in accordance with some embodiments, one or more modules, programs, software engines or processor instructions for performing at least some of the functionalities described herein. For example, control system 302 may comprise one or more software module(s) or engine(s) for directing one or more processors of vehicle apparatus 300 to perform certain functions. In some embodiments, software components, applications, routines or sub-routines, or sets of instructions for causing one or more processors to perform certain functions may be referred to as “modules” or “engines.” It should be noted that such modules or engines, or any software or computer program referred to herein, may be written in any computer language and may be a portion of a monolithic code base, or may be developed in more discrete code portions, such as is typical in object-oriented computer languages. In addition, the modules or engines, or any software or computer program referred to herein, may in some embodiments be distributed across a plurality of computer platforms, servers, terminals, and the like. For example, a given module or engine may be implemented such that the described functions are performed by separate processors and/or computing hardware platforms. Further, although certain functionality may be described as being performed by a particular module or engine, such description should not be taken in a limiting fashion. In other embodiments, functionality described herein as being performed by a particular module or engine may instead (or additionally) be performed by a different module, engine, program, sub-routine or computing device without departing from the spirit and scope of the invention(s) described herein.

It should be understood that any of the software modules, engines, or computer programs illustrated herein may be part of a single program or integrated into various programs for controlling one or more processors of a computing device or system. Further, any of the software modules, engines, or computer programs illustrated herein may be stored in a compressed, uncompiled, and/or encrypted format and include instructions which, when performed by one or more processors, cause the one or more processors to operate in accordance with at least some of the methods described herein. Of course, additional and/or different software modules, engines, or computer programs may be included, and it should be understood that the examples illustrated and described with respect to FIG. 8 are not necessary in any embodiments. Use of the terms “module” or “software engine” is not intended to imply that the functionality described with reference thereto is embodied as a stand-alone or independently functioning program or application. While in some embodiments functionality described with respect to a particular module or engine may be independently functioning, in other embodiments such functionality is described with reference to a particular module or engine for ease or convenience of description only and such functionality may in fact be a part of, or integrated into, another module, engine, program, application, or set of instructions for directing a processor of a computing device.

In some embodiments, the instructions of any or all of the software modules, engines or programs described above may be read into a main memory from another computer-readable medium, such from a read-only memory (ROM) to random access memory (RAM). Execution of sequences of instructions in the software module(s) or program(s) can cause one or more processors to perform at least some of the processes or functionalities described herein. Alternatively or additionally, in some embodiments, hard-wired circuitry may be used in place of, or in combination with, software instructions for implementation of the processes or functionalities described herein. Thus, the embodiments described herein are not limited to any specific combination of hardware and software.

In the illustrated example of FIG. 8, the control system 302 includes may include a route planning module 302a, an obstacle detection module 302b, and/or a drive control module 302c. Other modules or components are also possible according to one or more contemplated embodiments. In some embodiments, the route planning module 302a can be configured to plan a route for the vehicle to follow. In some embodiments, the route planning module 302a can employ data stored in database 310 regarding rules of the road and/or the road network or area to plan a route while avoiding known or detected obstacles in the environment. In some embodiments, the control system 302 can use signals from the sensors 304 to identify traversable paths through the area, for example, using vehicle position and/or features identified in the surrounding environment by one or more of sensors 304. In some embodiments, the drive control module 302c can then control the drive-by-wire system 306 (e.g., an electrical or electro-mechanical system that controls steering, gearing, velocity, acceleration, and/or braking) to have the vehicle (e.g., with trailer coupled thereto) follow the planned route. Alternatively or additionally, in some embodiments, the control system 302 can control the drive-by-wire system 306 based one or more signals received via communication unit 308 (e.g., transceiver for wireless communication), for example, to follow another vehicle (e.g., autonomous or manually-operated leader vehicle). In some embodiments, the obstacle detection module 302b can be configured to detect obstacles (e.g., impassable road features, other vehicles, pedestrians, etc.) as the vehicle moves. Control system 302 can be further configured to avoid the detected obstacles, for example, by instructing the vehicle to follow an alternative path.

In some embodiments, the vehicle can communicate with other vehicles and/or a communication infrastructure (e.g., cellular network) via communication unit 308 and/or computer network 320. The network 320 may, according to some embodiments, comprise a Local Area Network (LAN; wireless and/or wired), cellular telephone, Bluetooth®, Near Field Communication (NFC), and/or Radio Frequency (RF) network with communication links with the vehicle apparatus 300. In some embodiments, the network 320 may comprise one or many other links or network components other than those depicted in FIG. 8. The vehicle apparatus 300 may, for example, be connected via various cell towers, routers, repeaters, ports, switches, and/or other network components that comprise the Internet and/or a cellular telephone (and/or Public Switched Telephone Network (PSTN)) network, and which comprise portions of the network 320.

While the network 320 is as a single object, the network 320 may comprise any number, type, and/or configuration of networks that is or becomes known or practicable. According to some embodiments, the network 320 may comprise a conglomeration of different sub-networks and/or network components interconnected, directly or indirectly. The network 320 may comprise one or more cellular telephone networks with communication links with the communication unit 308 and/or may comprise an NFC, RAdio Detection And Ranging (RADAR), LiDAR, and/or other short-range wireless communication path, with communication links with the vehicle apparatus 300.

Alternatively or additionally, the communication unit 308 may employ a wireless communication modality, such as radio, ultra-wideband (UWB), Bluetooth, Wi-Fi, cellular, optical, or any other wireless communication modality.

The frameless image data capturing system of the present invention has other applications including, for example, in robotics and/or other virtual reality systems. The line-by-line image capture data may assist robots view in 3D while traversing industrial or manufacturing environments. In virtual reality devices, the 3D frameless image data can capture 360° video content without multiple static cameras of conventional systems.

In embodiments, the present invention is directed to a frameless, line-based stereo camera system capable of capturing full panoramic (360-degree) views in three dimensions. The frameless system of the present invention addresses inefficiencies of frame-based cameras (redundant data, heavy processing) by controlling exposure line-by-line and assembling a stereo image pair for VR or other stereo displays. This approach can be integrated into various platforms such as autonomous vehicles, industrial robots, and virtual reality systems-enabling improved resolution, lighter computational overhead, and fully panoramic 3D vision.

### III. Computer Implementation

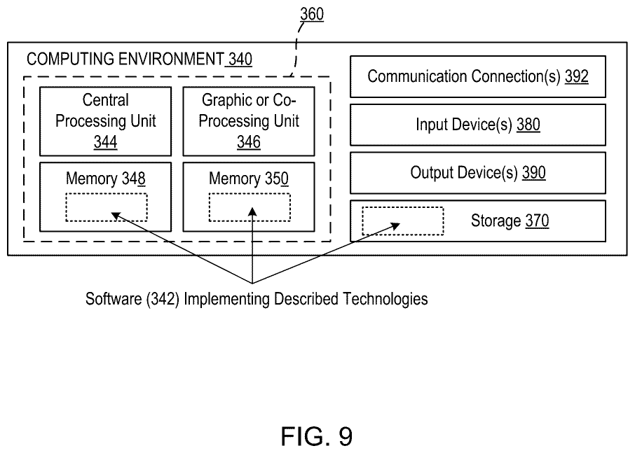

FIG. 9 depicts a generalized example of a suitable computing environment 340 in which the described innovations may be implemented. The computing environment 340 is not intended to suggest any limitation as to scope of use or functionality, as innovations may be implemented in diverse general-purpose or special-purpose computing systems. For example, computing environment 340 can be any of a variety of computing devices (e.g., desktop computer, laptop computer, server computer, tablet computer, etc.).

In the illustrated example, the computing environment 340 includes one or more processing units 344, 346 and one or more memories 348, 350, with this base configuration 360 included within a dashed line. The processing units 344, 346 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 9 shows a central processing unit 344 as well as a graphics processing unit or co-processing unit 346. The tangible memory 348, 350 may be volatile memory (e.g., registers, cache, RAM), non-volatile memory (e.g., ROM, EEPROM, flash memory, etc.), or some combination of the two, accessible by the processing unit(s). The memory 348, 350 stores software 342 implementing one or more innovations described herein, in the form of computer-executable instructions suitable for execution by the processing unit(s).

A computing system may have additional features. For example, the computing environment 340 includes one or more storage 370, one or more input devices 380, one or more output devices 390, and one or more communication connections 392. An interconnection mechanism (not shown) such as a bus, controller, or network interconnects the components of the computing environment 340. In some embodiments, an operating system software (not shown) can provide an operating environment for other software executing in the computing environment 340 and can coordinate activities of the components of the computing environment 340.

The tangible storage 370 may be removable or non-removable, and includes magnetic disks, magnetic tapes or cassettes, CD-ROMs, DVDs, or any other medium which can be used to store information in a non-transitory way, and which can be accessed within the computing environment 340. The storage 370 can store instructions for the software 342 implementing one or more innovations described herein.

The input device(s) 380 may be a touch input device such as a keyboard, mouse, pen, or trackball, a voice input device, a scanning device, or another device that provides input to the computing environment 340. The output device(s) 390 may be a display, printer, speaker, CD-writer, or another device that provides output from computing environment 340.

The communication connection(s) 392 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Python, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### IV. Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A frameless image data capturing system, which comprises:
a sensor mount including one or more line scan image sensors, the sensor mount couplable to a support; and
a control system operatively coupled to the sensor mount and the one or more line scan image sensors, the control system comprising one or more processors and at least one memory storing computer-readable instructions that, when executed by the one or more processors, cause the one or more processors to:
   selectively rotate the sensor mount relative to the support;
   capture, with the one or more line scan image sensors, image line data of an object at defined time instances;
   integrate the image line data to generate stereo image data of the object; and
transmit the stereo image data to a stereo image device;

Clause 2. The system according to claim 1 wherein the sensor mount includes first and second line scan image sensors.

Clause 3. The system according to claim 2 wherein the first and second line scan image sensors are arranged in diametric opposed relation on the sensor mount.

Clause 4. The system according to claim 1 wherein the one or more line scan image sensors are arranged in general orthogonal relation to the object.

Clause 5. The system according to claim 1 wherein the one or more processors are further configured to:
control an exposure time of the one or more line scan image sensors for a predetermined sector of rotation of the sensor mount.

Clause 6. The system according to claim 1 wherein capturing image line data includes obtaining, with the one or more image line scan sensors, multiple individual image line data at the defined time instances within a predetermined sector of rotation of the sensor mount.

Clause 7. The system according to claim 1 wherein the one or more line scan image sensors comprise a CMOS sensor.

Clause 8. The system according to claim 1 including at least one additional line scan image sensor.

Clause 9. The system according to claim 1 wherein each line scan image sensor comprises a plurality of adjacent vertical line sensors that are angularly offset relative to one another, and wherein the control system integrates partial exposures from each vertical line sensors as the sensor mount rotates, thereby creating a cumulative longer exposure for enhanced image quality.

Clause 10. The system according to claim 1 wherein the one or more line scan image sensors are configured for fast shutter operation with short integration times, such that the control system captures images of moving objects.

Clause 11. The system according to claim 1 wherein the one or more line scan image sensors each include an event-driven architecture configured to continuously detect changes in light intensity, and wherein the control system aggregates events from multiple angular positions to produce integrated stereo image data.

Clause 12. A method of capturing image data, comprising:
coupling one or more line scan image sensors to a sensor mount;
rotating the sensor mount;
capturing, with the one or more line scan image sensors, image line data of an object at defined time instances;
integrating the image line data to generate stereo image data of the object; and
transmitting the stereo image data to a stereo image device;
wherein the method is performed by one or more processors coupled to memory.

Clause 13. The method according to claim 12 wherein the one or more line scan image sensors include a first and second line scan image sensors, the first and second line scan image sensors.

Clause 14. The method according to claim 13 wherein the first and second line scan image sensors are arranged in diametric opposed relation on the sensor mount.

Clause 15. The method according to claim 14 wherein the line scan image sensors are arranged in general orthogonal relation to the object.

Clause 16. The method according to claim 15 including at least one additional line scan image sensor.

Clause 17. The method according to claim 12 including controlling an exposure time of the one or more line scan image sensors for a predetermined sector of rotation of the sensor mount.

Clause 18. The method according to claim 17 wherein capturing image line data includes obtaining, with the one or more image line scan sensors, multiple individual image line data at the defined time instances within the predetermined sector of rotation of the sensor mount.

Clause 19. The method according to claim 12 wherein the one or more line scan image sensors comprise a CMOS sensor.

### V. Rules of Interpretation

Throughout the description herein and unless otherwise specified, the following terms may include and/or encompass the example meanings provided. These terms and illustrative example meanings are provided to clarify the language selected to describe embodiments both in the specification and in the appended points of focus, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments. A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required. Although a product may be described as including a plurality of components, aspects, qualities, characteristics and/or features, that does not indicate that all of the plurality are essential or required. Various other embodiments within the scope of the described invention(s) include other products that omit some or all of the described plurality. A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the clauses. Accordingly, the clauses are intended to cover all such equivalents.

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise. Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A reference to “another embodiment” in describing an embodiment does not imply that the referenced embodiment is mutually exclusive with another embodiment (e.g., an embodiment described before the referenced embodiment), unless expressly specified otherwise.

The indefinite articles “a” and “an,” as used herein in the specification and in the clauses, unless clearly indicated to the contrary, should be understood to mean “at least one” or “one or more”.

The phrase “and/or,” as used herein in the specification and in the clauses, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or clauses are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods, as known to those of ordinary skill in the art. When directly and explicitly distinguishing embodiments from discussed prior art, the embodiment numbers are not approximating unless the word “about” is recited. Whenever “substantially,” “approximately,” “about,” or similar language is explicitly used in combination with a specific value, variations up to and including ten percent (10%) of that value are intended, unless explicitly stated otherwise.

Directions and other relative references may be used to facilitate discussion of the drawings and principles herein, but are not intended to be limiting. For example, certain terms may be used such as “inner,” “outer”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same. Similarly, while the terms “horizontal” and “vertical” may be utilized herein, such terms may refer to any normal geometric planes regardless of their orientation with respect to true horizontal or vertical directions (e.g., with respect to the vector of gravitational acceleration).

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Where a limitation of a first clause would cover one of a feature as well as more than one of a feature (e.g., a limitation such as “at least one widget” covers one widget as well as more than one widget), and where in a second clause that depends on the first clause, the second clause uses a definite article “the” to refer to the limitation (e.g., “the widget”), this does not imply that the first clause covers only one of the feature, and this does not imply that the second clause covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a clause to a ‘step’ or ‘steps’ of a process has sufficient antecedent basis.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining and the like. The term “computing” as utilized herein may generally refer to any number, sequence, and/or type of electronic processing activities performed by an electronic device, such as, but not limited to looking up (e.g., accessing a lookup table or array), calculating (e.g., utilizing multiple numeric values in accordance with a mathematic formula), deriving, and/or defining.

The terms “including”, “comprising” and variations thereof mean “including but not limited to”, unless expressly specified otherwise. As used herein, “comprising” means “including,” and the singular forms “a” or “an” or “the” include plural references unless the context clearly dictates otherwise. The term “or” refers to a single element of stated alternative elements or a combination of two or more elements, unless the context clearly indicates otherwise.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as ultra-wideband (UWB) radio, Bluetooth™, Wi-Fi, TDMA, CDMA, 3G, 4G, 4G LTE, 5G, etc.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

Embodiments of the disclosed subject matter can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

### VI. Conclusion

In embodiments, the present invention is directed to a frameless, line-based stereo camera system capable of capturing full panoramic (360-degree) views in three dimensions. The system addresses inefficiencies of frame-based cameras (redundant data, heavy processing) by controlling exposure line-by-line and assembling a stereo image pair for VR or other stereo displays. The methodology and system can be integrated into various platforms such as autonomous vehicles, industrial robots, and virtual reality systems-enabling improved resolution, lighter computational overhead, and fully panoramic 3D vision.

Although the system has been illustrated in the figures and discussed in detail herein, embodiments of the disclosed subject matter are not limited thereto. In practical implementations, embodiments may include additional components or other variations beyond those illustrated. Accordingly, embodiments of the disclosed subject matter are not limited to the particular vehicles, trailers, sensors, components, and configurations specifically illustrated and described herein.

Any of the features illustrated or described with respect to one of FIGS. 1-9 and the Clauses can be combined with features illustrated or described with respect to any other of FIGS. 1-9 and the Clauses to provide systems, methods, devices, and embodiments not otherwise illustrated or specifically described herein. All features described herein are independent of one another and, except where structurally impossible, can be used in combination with any other feature described herein.

The present disclosure provides, to one of ordinary skill in the art, an enabling description of several embodiments and/or inventions. Some of these embodiments and/or inventions may not be claimed in the present application, but may nevertheless be claimed in one or more continuing applications that clause the benefit of priority of the present application. Applicant intends to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the present disclosure.

What is claimed is:

1. A frameless image data capturing system, which comprises:
a sensor mount including one or more line scan image sensors, the sensor mount couplable to a support; and
a control system operatively coupled to the sensor mount and the one or more line scan image sensors, the control system comprising one or more processors and at least one memory storing computer-readable instructions that, when executed by the one or more processors, cause the one or more processors to:
selectively rotate the sensor mount relative to the support;
capture, with the one or more line scan image sensors, image line data of an object at defined time instances;
integrate the image line data to generate stereo image data of the object; and
transmit the stereo image data to a stereo image device.

2. The system according to claim 1 wherein the sensor mount includes first and second line scan image sensors.

3. The system according to claim 2 wherein the first and second line scan image sensors are arranged in diametric opposed relation on the sensor mount.

4. The system according to claim 1 wherein the one or more line scan image sensors are arranged in general orthogonal relation to the object.

5. The system according to claim 1 wherein the one or more processors are further configured to:
control an exposure time of the one or more line scan image sensors for a predetermined sector of rotation of the sensor mount.

6. The system according to claim 1 wherein capturing image line data includes obtaining, with the one or more line scan image sensors, multiple individual image line data at the defined time instances within a predetermined sector of rotation of the sensor mount.

7. The system according to claim 1 wherein the one or more line scan image sensors comprise a CMOS sensor.

8. The system according to claim 1 including at least one additional line scan image sensor.

9. The system according to claim 1, wherein each line scan image sensor comprises a plurality of adjacent vertical line arrays that are angularly offset relative to one another, and wherein the control system integrates partial exposures from each vertical line array as the sensor mount rotates, thereby creating a cumulative longer exposure for enhanced image quality.

10. The system according to claim 1, wherein each line scan image sensor is configured for fast shutter operation with short integration times, such that the control system captures images of moving objects.

11. The system of claim 1, wherein the one or more line scan image sensors each include an event-driven architecture configured to continuously detect changes in light intensity, and wherein the control system aggregates events from multiple angular positions to produce integrated stereo image data.

12. A method of capturing image data, comprising:
coupling one or more line scan image sensors to a sensor mount;
rotating the sensor mount;
capturing, with the one or more line scan image sensors, image line data of an object at defined time instances;
integrating the image line data to generate stereo image data of the object; and
transmitting the stereo image data to a stereo image device;
wherein the method is performed by one or more processors coupled to memory.

13. The method according to claim 12 wherein the one or more line scan image sensors include a first and second line scan image sensors, the first and second line scan image sensors.

14. The method according to claim 13 wherein the first and second line scan image sensors are arranged in diametric opposed relation on the sensor mount.

15. The method according to claim 14 wherein the first and second line scan image sensors are arranged in general orthogonal relation to the object.

16. The method according to claim 15 including at least one additional line scan image sensor.

17. The method according to claim 12 including controlling an exposure time of the one or more line scan image sensors for a predetermined sector of rotation of the sensor mount.

18. The method according to claim 17 wherein capturing image line data includes obtaining, with the one or more line scan image sensors, multiple individual image line data at the defined time instances within the predetermined sector of rotation of the sensor mount.

19. The method according to claim 12 wherein the one or more line scan image sensors comprise a CMOS sensor.
